(19) United States
(12) Patent Application Publication
(10) Pub. No.: US 2010/0027087 A1
(43) Pub. Date: Feb. 4, 2010

(54) IMPROVEMENTS TO OPTICAL CORRELATION APPARATUS

(75) Inventors: Andrew Charles Lewin, Malvern (GB); Gregor John McDonald, Malvern (GB); Douglas Alan Payne, Malvern (GB); Rebecca Anne Wilson, Malvern (GB)

Correspondence Address: OLIFF & BERRIDGE, PLC, P.O. BOX 320850, ALEXANDRIA, VA, 22320-4850, US

(73) Assignee: QINETIQ LIMITED, LONDON (GB)

(21) Appl. No.: 12/519,005

(22) PCT Filed: Dec. 17, 2007
(86) PCT No.: PCT/GB2007/004855

§ 371 Date: Jun. 12, 2009

(30) Foreign Application Priority Data
Dec. 16, 2006 (GB) 0625107.8

(51) Int. Cl. G06E 3/00

(52) U.S. Cl. 359/107

(57) ABSTRACT

An optical correlation apparatus is taught which provides a parallel optical signal having a phase modulation representing input data to which a parallel phase modulation based on reference data is applied. In the event of correlation the resulting wavefront is planar and can be interferometrically coupled to give a high intensity signal. The invention involves use of parallel amplitude modulation means for selectively blocking the optical signal in one or more of the channels of the parallel optical signal which allows different sized reference data strings to be searched more easily and also aids in calibration.

This invention relates to improvements to a method and apparatus for pattern recognition using optical correlation techniques.

Pattern recognition is concerned with the process of recognising one or more known objects in incoming data, for example text or imagery, by comparing known reference object(s) with the data. An ideal way to perform pattern recognition autonomously is through the mathematical operation of correlation. This patent is concerned with an improved correlator employing optical techniques for very high speed operation.

There are many areas in which pattern recognition is used, from interrogating databases to locate specific search terms to biometric based recognition systems and target identification in two-dimensional imagery. Often the search is performed digitally using a suitably programmed processor to compare a known reference data string with the data to be searched to identify a match. One example is an internet search engine which compares one or more input reference words with internet data to identify a match.

When searching very large amounts of data however software based pattern identification techniques may be slow or require very large processing power. Also when data is received at high data rates, for example at telecommunications data transfer rates, software based systems may be unable to perform correlation at this speed.

Recently it has been proposed to apply the benefits of optical correlation to high speed pattern matching. Our patent application PCT/GB2005/004028, published as WO2006/043057, describes a correlator apparatus that uses fast phase modulation and parallel optical processing to allow high speed correlation.

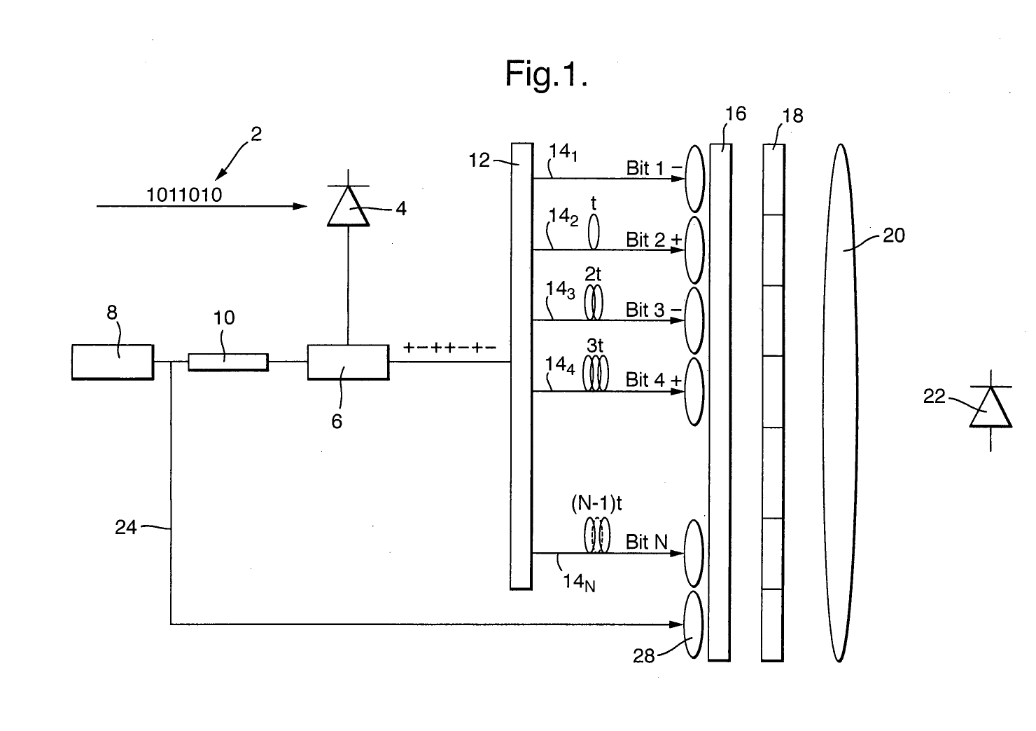

FIG. 1 shows a first embodiment of this fast optical correlator. The correlator acts on a temporal or sequential input data stream 2. This data stream may be, for instance, in the form of an amplitude modulated binary optical signal such as is used in telecommunications and may be streamed from a database to be searched for the existence of certain data. The amplitude modulated input signal 2 is detected by a photodetector 4. The detected data is used to control a phase modulator 6 which modulates the phase of a stable laser 8 to create a temporal binary phase modulated optical signal. High speed phase modulators exist in the field of telecommunications and can deal with very high input data rates. However the data could be input in any form, for instance it may arrive as amplitude modulated electric signals and these may be used directly to control phase modulator 6.

The phase modulated optical data signal is divided into a plurality of optical channels. In this embodiment each optical channel comprises a length of optical fibre 14₁-14_{N} Each of the fibre optical channels has a different delay length, each fibre having an incremental delay compared to the previous fibre related to the bit rate of the system—the incremental delay being equal to the bit duration. Thus at the output of the fibres 14 the first fibre will output the phase modulated signal equivalent to one particular bit whereas the next fibre, which has an increased delay, will output the phase modulated signal for the previous bit and so on. Therefore the output of each fibre will be a different bit in the signal. The apparatus therefore converts the temporal optical signal into a parallel optical phase signal. Optical delay means other than optical fibres can also be used.

The output of each fibre 14 is directed by a lens 28 onto part of a phase modulating spatial light modulator (SLM) 18. The spatial light modulator 18 displays a phase modulation pattern corresponding to at least one reference pattern (or its inverse)—the reference pattern corresponding to some reference data which is sought.

The phase of any one optical channel of the signal exiting the SLM will therefore depend on the phase modulation applied for that particular bit of input data and also the phase modulation for that part of the reference pattern. The phase modulations applied are designed such that where there is no correlation between the input data and the reference data the phase of the various channels in the resulting optical signal will vary randomly and hence the signal will have a wavefront with varying phase. However, where the reference pattern exactly matches (or is the exact opposite on the input data, the result will be that every optical channel has the same phase, in other words a plane wavefront will be produced. The system is preferably designed with binary phase modulation such that for each optical channel having a match between the input data and reference data the phase modulation applied results in a first phase state and for each channel having a mismatch between the input and reference data the phase modulation applied results in a second phase state, the first and second phase states being 180° out of phase.

The resulting optical signal is focussed by lens 20 to a point detector 22. In the case of no correlation the parts of the signal with the first phase state will destructively interfere with the second phase state of the other channels (this is a binary phase system). Therefore the optical signal will not be strongly focussed to the detector 22. However where there is a correlation, all the signal is in phase (in the first phase state) and hence the signal will be strongly focussed to the detector 22. Thus the intensity of the signal detected at the detector 22 can be used as an indication of correlation.

The SLM 18 may be arranged to display more than one reference pattern—this is useful where it is desired to search for more than one reference data string or where the search string is longer than the number of optical channels. In such a case the outputs of the fibre optics may be replicated into more than one parallel optical signal by replication optics 16. Imagine the outputs of the fibre optic delay lines 14 were arranged as a linear array. Replication optics 16, for instance a Dammann grating, may replicate the linear array of outputs in the transverse direction, i.e. a 40 channel array could be replicated 40 times to form a 40×40 array of outputs where each line is a copy of the parallel optical signal. These would be directed onto the SLM which would likewise be formed into a 40×40 array of modulation areas, each line representing a particular reference pattern. Obviously each line would have to be focussed separately to its own detector and so a linear array of 40 photodetectors would be used.

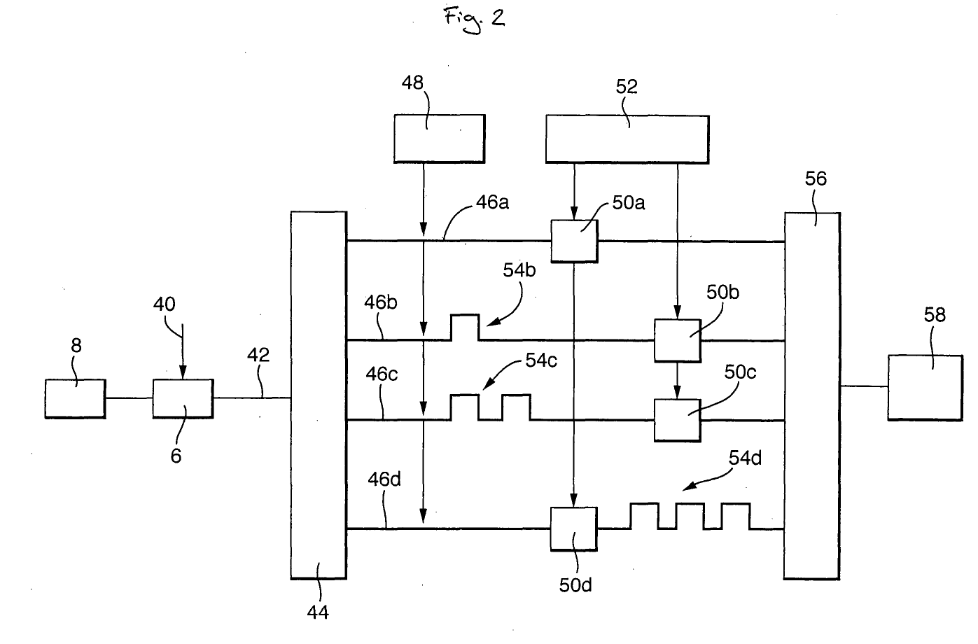

In another embodiment of this correlator the optical fibre delays are replaced with a series of integrated optic waveguides. FIG. 2 shows this embodiment. Here the input data stream 40 is again passed to a phase modulator 6 to phase modulate the output of laser 8 to produce a temporal phase modulated optical signal.

This signal is passed, via an input waveguide 42, to a 1-N MMI splitter 44. MMI splitter 44 is a multimode interference device which has an input waveguide 42, a multimode waveguide region and N output waveguides 46a . . . d (four are shown for ease of reference but in a working device the number of output channels may be much higher). The input optical signal excites multiple modes in the MMI device which is dimensioned such that replicas of the input are re-imaged at each of the output waveguides 46a . . . d. MMI splitters of this nature are well know in the art. Waveguides 46a . . . d are formed from any convenient material, for instance gallium arsenide, or may be free space waveguides formed in a semiconductor material such as silicon.

Amplitude modulation control 48 is provided for intensity matching to ensure optimal performance.

Each of the waveguides has a different length so as to give a different, incremental delay length in a manner similar to the different lengths of optical fibre described above, with the increment in delay from one waveguide to the next again being equal to the bit time of the incoming data. The skilled person will be well aware of how to construct waveguides of different length, for instance by incorporating additional turns 54b . . . d. The waveguides therefore convert the temporal input signal to a parallel optical data signal at the output.

However, unlike the first embodiment where the outputs of the optical fibres were passed to an SLM, each waveguide 46a . . . d has an associated phase modulator 50a . . . d controlled by phase modulator control 52. The phase modulator control controls the binary phase modulation applied to each waveguide and applies an appropriate phase modulation for a particular reference data string.

The reference phase modulation may be applied at any point in the delay line. The phase modulators need not be aligned and the delay to a particular waveguide may be applied before or after the phase modulator or both. Each waveguide having its own phase modulator means that there is no need to align the output of the optical delay means with an SLM as described above. Further any fine control to an individual channel is easy to achieve.

The phase modulators are integrated electro-optic modulators such as the skilled person would be well familiar with.

The outputs of waveguides 46a . . . d form the inputs to an MMI N−1 combiner 56. The MMI combiner couples the outputs of waveguides to a single output from the combiner which feeds to photodetector 58. Where all the inputs to the MMI combiner are in phase the signals constructively add whereas a phase mismatch with cause destructive coupling. MMI combiner 56 therefore effectively performs the same function as lens 20. The intensity on the detector can therefore be used as an indication of correlation as described above.

The principle of replication of the parallel optical signal could also be applied to this embodiment so as to search for several different reference strings simultaneously.

The correlator apparatus described therefore effectively converts input sequential data into parallel optical data by dividing the signal into several optical channels which have successive delays. A reference phase modulation is also applied to each optical channel and when there is a correlation between the reference data and input data each channel will have the same phase which can be detected by interferometric coupling of the optical channels. This apparatus can therefore operate at high speeds as the reference data applied to the SLM or EO phase modulators is effectively fixed for a certain data pattern.

The present invention relates to the above described fast optical correlator and seeks to improve the flexibility and/or calibration of the correlator.

Thus according to the present invention there is provided a correlation apparatus comprising an optical delay means for converting a temporal data input stream to at least one parallel optical data stream having a phase modulation replicating the input data and a reference phase modulator for applying a parallel phase modulation replicating at least one reference data set wherein the reference phase modulator and optical delay means are aligned so as to create a parallel optical signal which has been modulated in phase according to both input and reference data further comprising an intensity modulator acting on the parallel optical data stream or parallel optical data signal and capable of selectively reducing the intensity of radiation in one or more channels of the parallel optical data stream/parallel optical data signal to substantially zero.

The correlator of the present invention thus incorporates an intensity modulator into the correlation apparatus described in WO2006/043057 which is capable of selectively blocking radiation in one or more channels of the correlator. Being able to selectively block one or more channels of the correlator means that the correlator is more flexible for looking for search strings or parts of search strings which are of different size to the number of hardwired channels of the correlator.

As the number of channels of the correlator is fixed the number of bits of the reference data pattern is also fixed. As mentioned in WO2006/043057 this can mean splitting search strings which are larger than the number of available bits in the reference data pattern across several different reference patterns. Where the particular search string has fewer bits than the number of channels it is necessary to use several reference patterns and fill the remaining bits of each reference pattern with all possible data possibilities in order to be sure of a match. As will be understood, the correlation apparatus indicates a match when the whole of the parallel optical signal is in phase and the signal recorded at the detector is above the threshold intensity level. Therefore if the correlation apparatus has sixteen channels say it will only register a match when all sixteen channels are in phase, i.e. there is a correlation between the reference and input data in all sixteen channels. However imagine that the search string is fourteen bits long. The phase modulation applied to fourteen of the sixteen channels would correspond to the search term. When the input data matches the search term the outputs from these fourteen channels will be in phase. However whether the two remaining channels are in phase will depend on what the input data is and what reference phase modulation was chosen for those channels. As it will be wished to identify a match for the search term irrespective of what data is on the other channels this will require four separate reference data sets for a binary system, each having the same fourteen channel reference data pattern but a different one of the four possible data combinations for the other two channels. In this way if the search term is present in the input data it will create a match on the fourteen channels that represent the search term and whatever data happens to be on the other two channels it will match with on of the reference data sets and hence a match will be indicated.

The number of reference data sets needed will depend on the difference between the number of bits in reference search string and the number of channels of the correlator. If the correlator has forty channels and the search string only has thirty two bits in it then there are eight channels where every possible data combination needs to be encoded into a different reference data set, leading to 28 or 256 different reference data sets.

The present invention incorporates an intensity modulator to modulate the intensity of radiation in one or more channels and can reduce the intensity to zero in selected channels. In effect the intensity modulator can switch selected channels of so that there is no contribution from those channels. In this way the number of active channels can be controlled and a single reference data set used. In the first example given above where there are sixteen channels and a fourteen bit search string is used the intensity modulator would block radiation in the two channels which did not correspond to the search string and thus ensure no radiation from these channels reached the detector. As two channels are being blocked the threshold on the detector would have to be adjusted to indicate a match from fourteen channels rather than sixteen but this can easily be done based on the selected number of channels. Thus when the input data matches the search string on the fourteen active channels the optical signal will be in phase and will produce an output above the threshold for a fourteen channel combination. The other two channels are effectively blocked and hence do not contribute at all, no matter what phases are encoded on the optical signals due to the input data.

Therefore the present invention can allow the correlation apparatus of WO2006/043057 to handle an input search string of any length and does not require matching of the reference data set to the number of channels of the correlation apparatus. This allows searching for a pattern with fewer bits than the number of channels of the correlator with only a single reference data set.

Furthermore the present invention offers advantages in calibrating the correlation apparatus to account for any phase drift occurring, for instance due to temperature variations. In the embodiment of the correlator which uses fibre delays lines and a phase modulating SLM temperature variations in the fibre lines and/or across the SLM can lead to unwanted phase variations in individual channels. The correlation apparatus can be correlated by using an analogue SLM and adjusting the phase modulation applied. One way to determine any phase drift is to introduce a known input signal which matches the reference data set and determine the peak intensity detected. However the peak intensity is of the combined parallel optical signal rather than a particular channel. Using the present invention a particular channel or set of channels can be calibrated by using the intensity modulator to reduce the intensity in all other channels to zero. Thus only the channel or channels under test contributes a signal to the detector and this can be compared to the expected intensity level. Calibrating one or a few channels in this way gives greater control and offers better and faster calibration than trying to calibrate all channels at the same time.

The present invention therefore is a relatively simple addition to the correlator described in WO2006/043057 but increases the flexibility and robustness thereof.

The intensity modulator may be an amplitude modulating spatial light modulator (SLM). Amplitude modulating SLMs are well known and are relatively cheap and available. The amplitude modulating SLM could be located in the optical path before or after the optical delay means. In embodiments of the correlator where the reference phase modulator comprises a phase modulating SLM the amplitude modulating SLM may be co-located with the phase modulating SLM, again either before or after the phase modulating SLM. All that is required is that the amplitude modulating SML is located in the optical path prior to an interferometric coupler.

In the embodiment of the correlator where the optical delay means comprises integrated optics the intensity modulator could comprise an amplitude modulating SLM located at an output of the integrated optics. However it may be preferable in these circumstances to use a separate electro-optic intensity modulator on each channel. As described above in the integrated optic embodiment of the correlator may include an amplitude modulator for modulating the intensity of each channel to a uniform value. In the present invention this amplitude modulator could be adapted or replaced by a modulator which is capable of reducing the intensity of radiation in a channel to zero.

The invention will now be described by way of example only with reference to the following figures of which,

FIG. 1 shows a first embodiment of a correlator as described in WO2006/043057,

FIG. 2 shows an alternative embodiment of a correlator as described in WO2006/043057,

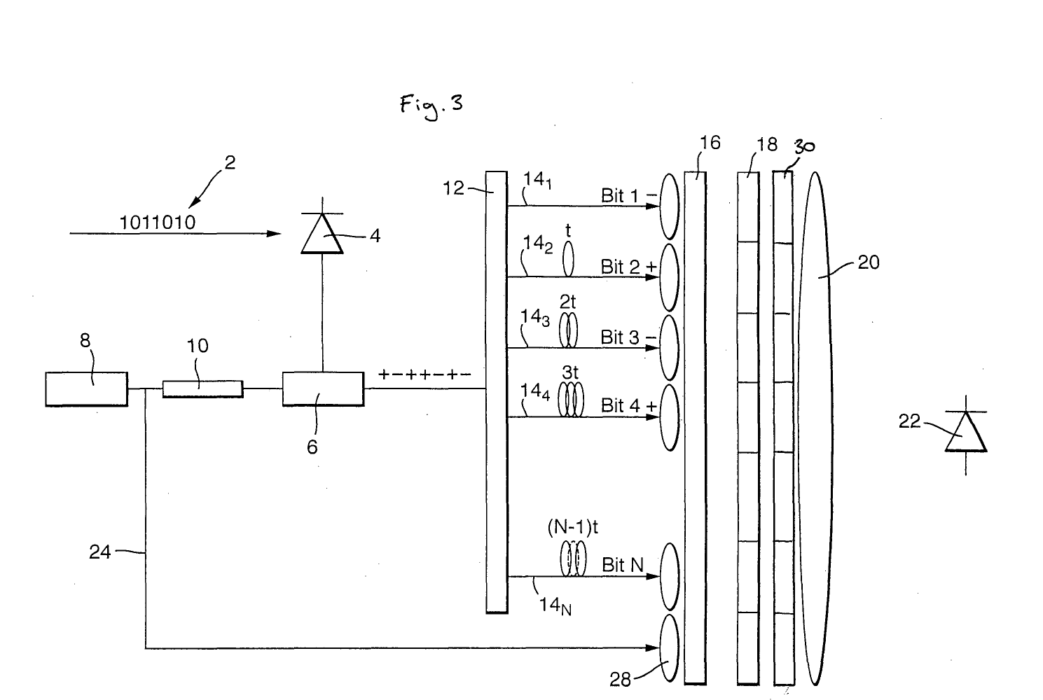

FIG. 3 shows an embodiment of the present invention,

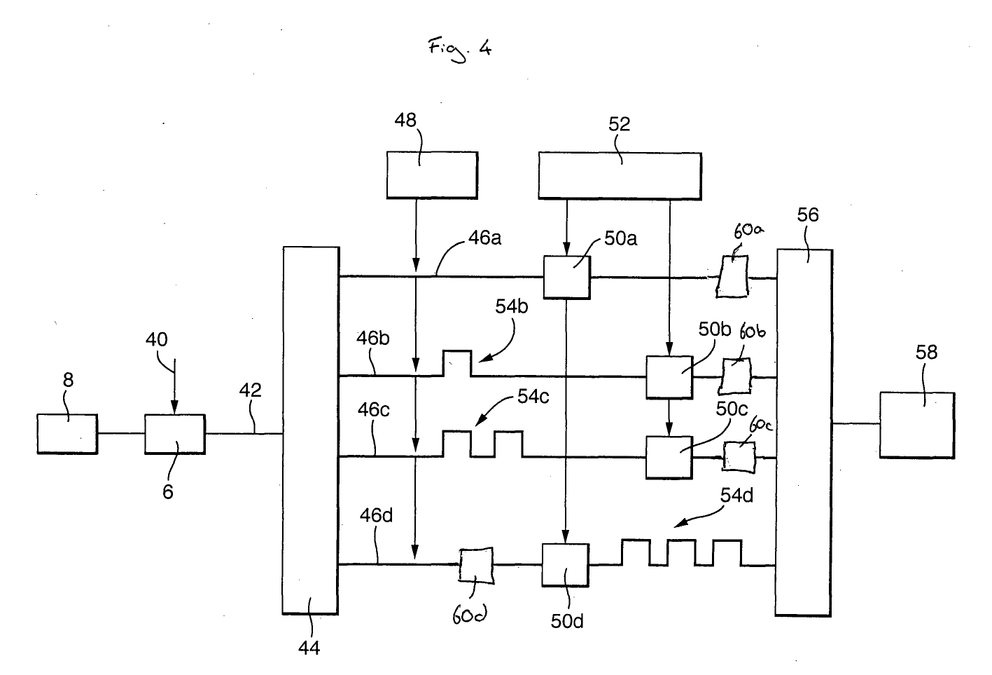

FIG. 4 shows an alternative embodiment of the present invention.

As described above FIG. 1 shows an embodiment of a correlator described in WO2006/043057, the contents of which are hereby incorporated by reference thereto, especially the description of this embodiment of the correlator from page 16, line 14 to page 20, line 17.

Summarizing briefly the operation of this embodiment of the correlator input data, which may be in the form of an optical binary signal 2 is detected by a photodetector 4 and used to control a phase modulator 6. The phase modulator 6 acts on the output of stable laser 8, amplified by amplifier 10, to produce an optical data input having a binary phase modulation representing the input data.

Beam splitter 12 splits this phase modulated signal into N different beams and each beam is fed into a different channel of an optical delay means. As used herein the term channel shall mean a separate optical pathway through the correlator which may be within a waveguide or, at least partly in free space transmission.

The optical delay means comprises a plurality of lengths of fibre optic cable 14₁-14_{N} each fibre optic cable having a different delay, the difference in delay between one fibre and the next being equal to the bit period t. In this way the output of the fibres 14₁-14_{N} is a parallel optical signal comprising N bits of the input data stream. The outputs from each fibre are focussed by a lenslett in lenslett array 28 onto a Dammann grating 16 which produces several transversely separated copies of the parallel optical signal. Each of the parallel optical signals is incident on phase modulating SLM 18.

Considering just one of the parallel optical signals the output from each fibre 14₁-14_{N} is incident on a separate area of the phase modulating SLM which applies a phase modulation in that area based on a binary reference data pattern. The phase modulations applied by the phase modulator 6 and SLM 18 are such that the combination of an input data phase modulation corresponding to a binary 1 with a reference phase modulation corresponding to a binary 1 produces an effective phase modulation is the same as an input phase modulation corresponding to binary 0 being combined with a reference phase modulation corresponding to a binary 0 but which is out of phase (preferably π out of phase) with the overall modulation resulting from the combination of an input binary 1 with a reference binary 0 or vice versa.

Therefore if there is an exact match between the input data and the reference data parallel optical signal exiting the SLM will be in phase across each channel. However where there is no correlation the phase of the parallel optical signal will vary across the channels.

The parallel optical signal transmitted by the SLM is focussed by a lens 20 onto a detector 22. When the whole optical signal is in phase it is in effect a planar wavefront and thus is strongly focussed to the detector. However if even one channel is out of phase this will destructively interfere with the signal in other channels and thus the signal at the detector will be reduced, Thus a detector signal strength above a certain intensity is used as an indication of a pattern match.

It will be appreciated that a perfect mis-match, i.e. each input data 1 being matched to a reference data 0 and vice versa would also produce a plane wavefront and hence would be strongly focussed onto detector 22. Therefore a reference phase bit 24 is provided which is arranged to undergo the same effective phase modulation as a matching input/reference data modulation. This additional reference bit will only be in phase in the matching case and will be out of phase in the case of perfect mis-match.

The correlator as described can be made with a large number of channels for each parallel optical signal, for instance the optical delay means could comprise 40 or 50 different delay lines. This can allow searching for long strings of data. Further, as mentioned the Dammann grating 16 produces replicas of the parallel optical signal. The fibre delay lines may be arranged to have a linear output array extending in the x direction. The Dammann grating then produces several copies of the optical signal separated in the y direction. The phase modulating SLM is two dimensional and can modulate all the parallel optical signals simultaneously. An array of lenses 20 would then focus each separate parallel optical signal to a different detector 22. Therefore the reference phase modulation applied to different parallel optical signals could be different to search for several different search terms simultaneously. A search term longer than 40 or 50 bits long, i.e. bigger than the number of channels in the optical delay means and so number of channels in each optical parallel signal, could be spread across several different parts of the phase modulating SLM. As the input data changes and so the modulations of the parallel optical signals also change one could look for instances of a match to different search sub-units at appropriate times.

Using the apparatus described above to search for a search term which is smaller than the number of channels is problematic without using several different reference data sets to account to all possible modulations on the channels not of interest. For instance imagine that there are 40 fibre optical delays in the optical delay means but that the reference pattern to be searched for is 37 bits long. The reference phase modulation pattern displayed on the SLM corresponding to bits 4-40 are fixed according to the search pattern. When a match is present in the input data stream the data is encoded in the input phase modulation and will reach the channels corresponding to bits 4-40 in due course. At that time the outputs from the channels corresponding to bits 3-40 will be in phase. However in order to detect a match all channels must be in phase. As a match should be detected whatever the input data on bits 1-3 eight different reference phase patterns must be displayed on the SLM 18, each having the same modulation for bits 4-40 but a different one of the eight possible combinations for bits 1-3.

Referring now to FIG. 3 an embodiment of the present invention is shown. The same components as shown in FIG. 1 are designated with the same numerals. The apparatus is that same as that shown in FIG. 1 with the addition of an amplitude modulating SLM 30. The amplitude modulating SLM has the same dimensions as the phase modulating SLM 18 and is collocated therewith. The amplitude modulating SLM is controlled to either transmit or block radiation in any particular channel from reaching the detector 22.

With reference to the example given above in this instance the 37 bit reference pattern may be represented by the appropriate phase modulation pattern on the SLM for bits 4-40. Bits 1-3 may be given any arbitrary phase modulation. However amplitude modulating SLM is controlled to be transmissive for bits 4-40 but to non-transmissive for bits 1-3. Therefore no radiation from these channels is transmitted by the amplitude modulating SLM and hence these channels have no effect on the radiation focussed to the detector.

In effect the amplitude modulating SLM simply switches certain channels off and makes the correlator act as a 37 channel correlator. The threshold for detecting a match would need to be adjusted to take account of the fact that three channels have been blocked and that a perfect match would now only result in 37 channels being combined in phase, however the various threshold levels could be pre-stored and linked to the number of channels blocked by the amplitude modulating SLM.

The amplitude modulating SLM could be any device which is capable of selectably changing the transmission. Note as used herein the term transmissive shall mean allowing radiation to reach the detector and non-transmissive shall mean preventing radiation from reaching the detector. It is no limited to meaning the amount of radiation passing through the modulator. The amplitude modulator could be a reflective device and could be arranged to either reflect light to the detector (transmissive) or absorb/reflect away from the detector (non-transmissive). Suitable amplitude modulating SLMs include liquid crystal devices, micro-mirror arrays, MEMS optical modulators or optical shutter arrays etc. The amplitude modulating SLM may be a reconfigurable mask.

Note that as shown the amplitude modulating SLM is located after the phase modulating SLM in the optical path. This is a convenient location as it ensures no differential heating of the phase modulating SLM by preventing radiation from reaching parts thereof. However it could be located in front of the phase modulating SLM or even at the output of the fibre delay line or prior to the input of the delay line. If the amplitude modulating SLM is located prior to Dammann grating 16 however then obviously it will block a channel in each replicated parallel optical signal. If it is located after the Dammann grating it could block channels in some parallel optical signals but not other. This could make it easier to search for strings longer than the number of channels. For instance a 64 bit search term could have bits 1-40 encoded in one reference phase pattern and bits 41-60 encoded in a second reference phase pattern, with the amplitude modulating SLM being arranged to block radiation in the twenty channels which don't correspond to any part of the search term.

The present invention is also advantageous in terms of calibrating the system. As described in WO2006/043057 at page 20, line 19 to page 21, line 12, incorporated herein by reference thereto, some phase drift of the system may occur and could result in unwanted phase variations and therefore it is advantageous to calibrate the system. This could be done by injecting a known input signal which is shorter than the bit period long whilst displaying a known reference pattern. The known input signal will ripple across each output in turn and the resulting modulation could be combined with the reference bit. Fine adjustments to the phase of the reference modulation for each part of the phase modulating SLM could then be made to ensure that matching input and reference modulations give the maximum intensity signal at the detector when combined with the reference bit and non-matching modulations given a minimum intensity signal at the detector.

Using an input signal shorter than the bit period long is necessary to ensure each channel is adjusted separately but it can be difficult to achieve and does not allow much time for adjustment.

With the present invention the amplitude modulating SLM could be used to block radiation from all but one channel and the reference bit from reaching the detector. A constant input phase modulation can then be applied and only the single channel can adjusted.

The invention may also be implemented in the integrated optics embodiment of the correlator described in WO2006/043057. Referring to FIG. 2 the operation of this embodiment of the correlator is described above in the introduction and is similar to the fibre optic embodiment described above with the difference that different lengths of integrated optic waveguides 46a-d are used to create the optical delay lines and electro-optic phase modulators 50a-d modulate each channel of the delay line with the appropriate reference phase modulation. An beam combiner 56 such as an MMI device interferometrically couples the outputs of the delay lines and the combined signal is passed to detector 58.

This correlator embodiment already includes an amplitude modulator 48 for ensuring each channel has an optical signal of the same amplitude. Referring now to FIG. 4 in the present invention the apparatus further comprises a series of intensity modulators 60a-d, one for each waveguide, that can be arranged to either allow or prevent radiation from reaching the beam combiner 56. For instance the intensity modulators could be optical shutters which effectively close the waveguide or optical switches which can be switched to direct the radiation to the beam combiner or to a different waveguide to lose the radiation through absorption or transmission. Therefore in the same manner as described above certain channels can be effectively deactivated for the same reasons as described above and with the same advantages.

1. A correlation apparatus comprising optical delay lines for converting a temporal data input stream of input data to at least one parallel optical data stream having a phase modulation replicating the input data and a reference phase modulator for applying a parallel phase modulation replicating at least one reference data set of reference data wherein the reference phase modulator and optical delay lines are aligned so as to create a parallel optical signal which has been modulated in phase according to both input data and reference data further comprising an intensity modulator acting on the parallel optical data stream or the parallel optical data signal and capable of selectively reducing the intensity of radiation in one or more channels of the parallel optical data stream or the parallel optical data signal to substantially zero.

2. A correlation apparatus according to claim 1 wherein the intensity modulator is an amplitude modulating spatial light modulator.

3. A correlation apparatus as claimed in claim 2 wherein the reference phase modulator comprises a phase modulating spatial light modulator and wherein the amplitude modulating spatial light modulator is co-located with the phase modulating spatial light modulator.

4. A correlation apparatus as claim 1 wherein the optical delay lines comprise a plurality of integrated optic waveguides wherein the intensity modulator comprises an intensity modulator arranged to act on each waveguide.

5. A correlation apparatus as claimed in claim 4 wherein the intensity modulator comprises one of an optical shutter, an optical switch and an electro-optic amplitude modulator.

6. A correlation apparatus as claimed in claim 1, further comprising a detector with a detection threshold, wherein the detection threshold is linked to a number of channels of the parallel optical data stream or the parallel optical data signal in which the intensity of radiation has been reduced to substantially zero.

7. A method of using a correlation apparatus to indicate correlation between input data and reference data, the correlation apparatus comprising optical delay lines for converting a temporal data input stream of input data to at least one parallel optical data stream having a phase modulation replicating the input data and a reference phase modulator for applying a parallel phase modulation replicating at least one reference data set of reference data wherein the reference phase modulator and optical delay lines are aligned so as to create a parallel optical signal which has been modulated in phase according to both input data and reference data, the correlation apparatus further comprising an intensity modulator acting on the parallel optical data stream or the parallel optical data signal and capable of selectively reducing the intensity of radiation in one or more channels of the parallel optical data stream or the parallel optical data signal to substantially zero, wherein the method comprises the steps of:
determining a number of bits in a reference data set;
using the intensity modulator to reduce the intensity of radiation in one or more channels such that only a number of channels in which intensity of radiation has not been reduced is equal to the number of bits in the reference data set; and
indicating correlation between input data and output data on the basis of the parallel optical data signal without contribution from the one or more channels in which the intensity of radiation has been reduced.

8. A method as claimed in claim 7, wherein the correlation apparatus comprises a detector with a detection threshold, and further comprising the step of linking the detection threshold to a number of channels of the parallel optical data stream or the parallel optical data signal in which the intensity of radiation has been reduced to substantially zero.

9. A method of calibrating a correlation apparatus used to indicate correlation between input data and reference data, the correlation apparatus comprising optical delay lines for converting a temporal data input stream of input data to at least one parallel optical data stream having a phase modulation replicating the input data and a reference phase modulator for applying a parallel phase modulation replicating at least one reference data set of reference data wherein the reference phase modulator and optical delay lines are aligned so as to create a parallel optical signal which has been modulated in phase according to both input data and reference data, the correlation apparatus further comprising an intensity modulator acting on the parallel optical data stream or the parallel optical data signal and capable of selectively reducing the intensity of radiation in one or more channels of the parallel optical data stream or the parallel optical data signal to substantially zero, wherein the method of calibrating the correlation apparatus comprises the steps of:
selectively reducing the intensity of radiation in all except one channel to be calibrated;
providing a constant input phase modulation; and
adjusting a phase modulation provided by the reference phase modulator to the one channel to be calibrated.
